(19) United States
(12) Patent Application Publication
(10) Pub. No.: US 2003/0004941 A1
(43) Pub. Date: Jan. 2, 2003

(54) Method, terminal and computer program for keyword searching

(75) Inventors: Seiji Yamada, Ebina-shi (JP); Junichi Satoh, Chigasaki-shi (JP)

Correspondence Address: John L. Rogitz, Rogitz & Associates, Suite 3120, 750 B Street, San Diego, CA, 92101, US

(73) Assignee: International Business Machines Corporation, Armonk, NY (US)

(21) Appl. No.: 10/176,452

(22) Filed: Jun. 19, 2002

(30) Foreign Application Priority Data
Jun. 29, 2001 (JP) JP2001-200189

(51) Int. Cl. G06F 7/00

(52) U.S. Cl. 707/3

(57) ABSTRACT

To provide a keyword search method and a keyword search terminal that can retrieve keywords efficiently. Indicators M1 and M2 are displayed on tree-like chart L that shows the logical structure of a document and titles of chapters Ta, sections Tb, and topics Tc, in the document when displaying search result, thereby denoting locations that include keywords specified by the user.

### I. FIELD OF THE INVENTION

The present invention relates to a keyword search method and a keyword search terminal.

### II. BACKGROUND OF THE INVENTION

Personal computers have commonly been used in recent years and it is widely known that various kinds of traditional documents such as dictionaries are available electronically. PC user is able to search keywords in electronic documents using the PC. The user use “keyword search function” to find out the location where desired terms are presented in the electronic documents.

In addition, the keyword search function is also available in online helps for both OS (Operating System) and various kinds of application programs installed on PC. By specifying desired keyword(s) for the search function, the user can find a location where the keyword(s) appear in the help text.

The keyword search, from the viewpoint of the search process executed in a computer, is classified into two types; “keyword search” and “full text search”. In the “keyword search”, specific words are registered as keywords beforehand and the search function is performed against only the registered keywords. In the “full text search”, the search function is performed against all the character strings in a document.

The search results are presented in a window displayed on the computer screen. In many cases, the inside area of the window is divided into several frames (for example, right and left), and the titles of the searched topics are listed in one frame and the contents of the topic the user selected in one frame are displayed in another frame. (In this case, a topic means a minimum unit of the document.) In other cases, a list of keywords registered in a document is displayed in one frame while the contents of the topic to which a selected keyword is registered are displayed in the other frame.

### III PROBLEMS TO BE SOLVED BY THE INVENTION

The user of the conventional search method as described above might not feel much inconvenience, but the user is often forced to open many topics before the user finds a desired topic if the document is enormous in volume and there are many topics found by the search operation. Thus, a keyword search operation can be a time-consuming job. One of the typical scenarios for such time-consuming keyword search operation is as follows:

Assume the user wants to know the definition of a word in a help file for an application program. The user initiates search operation by specifying the word as a keyword expecting that the definition of the word can be found in the help file. After the search operation is completed, all the topics that include the word are extracted. In this case, however, it is not easy for the user to find the desired topic immediately because the user has to see which topic is most suitable for the user's needs by opening each topic and reading the contents of the topic.

When specifying keyword(s), the user often selects keyword(s) from a list of all the keywords registered to the document. Or, in some cases, the user inputs the keyword(s) by hand. And if the specified keyword(s) are inappropriate, the user will get no meaningful results.

It is an objective of the present invention to provide a keyword search method, a keyword search terminal, etc. that enable more efficient keyword search.

### SUMMARY OF THE INVENTION

In order to achieve the above objective, the present invention proposes a keyword search method to be executed on a terminal. The method is targeted for electronic documents such as dictionaries, help files, or the like. Because these electronic documents consist of some unit documents, the method tries to find one or more unit documents which include specified keyword(s) by searching through all the keywords which exist in the entire document. After the search operation is completed, the method will show some indicators to highlight which unit document(s) include the specified keywords. Those indicators are shown on a document structure chart which shows the relationship among the unit documents.

An example of the document structure chart as described above is a tree-like chart which shows the relative position of the topics to the upper groups such as sections and chapters. In this case, a topic is the lowest unit in a unit document, and the topic position is indicated with its title. The position of the upper groups are also indicated with their titles. Indicators are shown on topic and upper group titles. Another example of the document structure chart is a sequence chart, which shows the sequence of the topics in a document. A typical example is a visual representation of linked topics described in a markup language such as HTML (Hypertext Markup Language). In this case, indicators are show with the topics on the sequence chart.

Using the keyword search method as described in the present invention, it is possible to know which portions (namely, unit documents) in the document include the desired keyword(s) by referring to the indicators displayed on the document structure chart. This chart is organized just like table of contents for an actual book, so it is possible for the user to guess if the specific portion really contains the information the user wants by examining the title marked with the indicator, or the title of the upper group (namely section or chapter).

The method proposed in the present invention uses base data for keyword search. The base data is generated by extracting keywords and their positions in a document before the user begins any actual search operation. Along with generating the base search data, data for showing document structure chart can also be generated by examining how the document is composed of unit documents.

The method proposed in the present invention is more suitable for searching keywords throughout the unit documents in a single document than for searching keywords defined in web pages on the Internet.

The proposed search method can be considered as a keyword search method applied to the documents whose topic data is stored in a database. The search operation is performed using a computer terminal. To enable this search method, keywords are registered to relating topics in advance. It is possible to show all the keywords in a single topic using a pull-down list, so the user selects desired keyword(s) from the pull-down list to initiate search operation.

In some cases, a trigger to open a dialog panel can be included in the pull-down list. A dialog panel is shown by selecting the trigger, thus enabling the user to specify any desired keyword(s) the user wants.

As descried earlier, the search result will be shown on a document structure chart with topics marked by indicators.

The proposed search method can be described as a keyword search terminal which performs keyword search operation against documents which consist of unit documents. The keyword search terminal includes a method to specify keywords to be searched and a method to display the search result by showing indicators to highlight where the desired keywords are included in the document.

Actual search program and documents to which the search function is applied can be placed on a server. In this case, the client terminal provides only search interface. Or the client terminal can host both the data for keyword search and search program itself.

The document data for keyword search can be stored in a database. The client terminal host the database or it can connect to a server which host the database via a network.

The proposed search method can be described as a computer program which enables a computer device to perform keyword search operation against documents stored in a database. The program provides a method to specify keywords to be searched and a method to locate portions where the specified keywords are used in the document, and a method to show the search result by displaying indicators to highlight where the desired keywords are included in the document.

The proposed search method can be described as a computer program which perform keyword search operation against documents stored in a database. The program provides a method to generate base data for keyword search by examining keywords and unit documents in which the keywords are defined. The program also provides a method to generate data to show the relationship among the unit documents, thus enabling the program to show specific unit documents on the document structure chart in order to highlight where the desired keywords are actually used.

The proposed search method can be described as a computer program which perform keyword search operation against documents. The contents data for topics in the document are stored in a database. The program identifies the keywords registered to the topic being shown on the screen when the user initiates the keyword search function, and shows the keywords on a list. The program performs keyword search operation using the keyword which the user selected from the keyword list.

### PREFERRED EMBODIMENT OF THE INVENTION

The present invention will be described in detail using the attached drawings as a reference.

FIG. 1 shows a module block diagram of a keyword search system in an embodiment of the present invention. As shown in FIG. 1, the keyword search system is realized on such a terminal (keyword searching terminal) as a PC or the like. The following components comprise the system: document database (database) 10 that stores electronic data of one or more documents; keyword search program 20 for searching keywords in response to user's request using the data stored in document database 10; display unit 30 for displaying search results, etc. obtained from keyword search program 20.

Document database 10 is physically composed of various kinds of recording media such as HDD (Hard Disk Drive), CD (Compact Disk)-ROM (Read Only Memory), DVD (Digital Versatile Disk)-ROM, or the like, as well as the reading apparatus. Database 10 stores electronic data of such documents as, for example, help files for application programs, dictionaries, etc. Each document stored in document database 10 has a structure (hereinafter referred to as a logical structure of a document) represented by hierarchical layers such as chapters, sections, topics, etc. A title is given to each of those chapters, sections, topics, etc. A topic is the lowest unit of a document. It has a title and a body text. (In the present invention, the term “topic” will be used intentionally to represent a text unit which is actually a “paragraph”. This is to keep consistency of terminology and explanation simplicity.)

Keyword search program 20 is realized by a computer program installed on a PC. The following components comprise keyword search program 20:

Document analysis module 21 (to be described later)

Data repository 22 (repository to store information for keyword search)

Document data processing module 23 (core of keyword search logic)

Input processing module 24 to receive keywords which the user specified using keyboard and various kinds of input devices

Event processing module 25 to control document data processing module 23 and view control module 26 depending on the user's input received by input processing module 24

View control module 26 to manage screen image rendered on display unit 30

Document analysis module 21 includes keyword index creation module 21a and document structure analysis module 21b. Keyword index creation module 21a retrieves data of a document stored in document database 10 and creates keyword index table 22a using the extracted keywords. Document structure analysis module 21b analyses the structure of the document to generate document structure table 22b.

Keyword index creation module 21a extracts keywords from a document and assigns a specific index value to each extracted keyword. Keyword index table 22a is loaded with those keywords and indexes.

Document structure analysis module 21b analyzes the logical structure of a document. In the analysis process, topics, sections and chapters in a document are detected. A topic is the lowest unit in a document, and a section consists of topics, and a chapter consists of sections. Then document structure analysis module 21b creates document structure table 22b using the information on the detected topics/sections/chapters in order to show the document structure in a tree-like manner. In creating the document structure table, document structure analysis module 21b analyzes which topic contains which keywords and how topics/sections/chapters are structured hierarchically, then refers to keyword index table 22a to relate keyword index values to document structure.

Keyword index table 22a and document structure table 22b created by document analysis module 21 are stored in data repository 22. If two or more document data are stored in document database 10, keyword index table 22a and document structure table 22b are created for each document and stored in data repository 22.

View control module 26 controls how the data generated by document data processing module 23 should be displayed on display unit 30. View control module 26 splits window W shown on the display unit 30 into two frames, for example, right and left frames, as shown in FIG. 2, so that a document structure chart L is shown in frame F1 and the contents of a topic (unit document) selected by the user is shown in frame F2. Document structure chart L can be described as follows:

A chart to show the structure of a document in tree-like manner

A chart to show the mutual relationship among topic Tc, section Tb, and chapter Ta,

A chart to show hierarchical structure in a document

After the document structure chart is shown on the screen of display unit 30, the user can perform various kinds of operations using mouse pointer shown on the screen. Two examples follow:

If the user clicks or double-clicks on chapter icon Ta of document structure chart L in frame F1, then section icon Tb which is just one layer lower than the chapter indicated by icon Ta appears. Similarly, if the user clicks or double-clicks on section icon Tb, then topic icon Tc appears in frame F1

If the user clicks or double-clicks on topic icon Tc, then the contents of topic Tc appears in frame F2

In order to implement functions described above, event processing module 25 receives events form input processing module 24 and controls view control module 26 depending on the type of the events. Such implementation is nothing special compared to the one widely used in real word application programs.

If the user points to a specific topic title in frame F1 by the mouse pointer and initiates search operation, event processing module 25 makes view control module 26 show keywords list on popup menu Pm at the position of the mouse pointer. (If the user initiates keyword search function with text cursor located in the frame which shows topic contents, keywords list is shown on a popup menu at the position of the text cursor.) The data to show the popup menu is obtained from document data processing module 23. In popup menu Pm, all the keywords registered for topic Tc are listed. Document structure table 22b holds the information about which keywords are registered to topic Tc.

Document data processing module 23 handles the execution of searching the keyword(s) the user specified using input device such as keyboard or pointing device. Document data processing module 23, however, does not access directly the data in the documents stored in document database 10. It uses keywords index table 22a and document structure table 22b in data repository 22. Both tables are generated by document analysis module 21 by analyzing the structure of documents.

The search result is shown in tree-like chart L which indicates the document structure with indicators M1 and M2 shown on titles of topic Tc, section Tb, and chapter Ta. The user recognizes which topic or section or chapter include the keywords the user specified by referring to indicators M1 and M2.

Described below is an actual implementation mechanism for the keyword search system proposed in the present invention.

FIG. 4 shows how document analysis module 21 generates keyword index table 22Sa and document structure table 22b before the user initiates keyword search operation. As shown in FIG. 4, keyword index creation module 21a of document analysis module 21 extracts the keywords from the documents stored in document database 10 (step S101). If the contents of the documents are marked up by a markup language, for example, XML (eXtensible Markup Language), a specific element in the contents can be easily distinguished from other elements. In this case, keyword index creation module 21a can extract keywords in a unit document by searching all the elements marked up by a tag which indicates keyword. If there are multiple occurrences for a single keyword, all of the duplicated keywords are eliminated. Then, keyword index creation module 21a assigns unique index value to each keyword. (step S102) A pair of a keyword and its index value is written into a record, and all of the records are stored into keyword index tables 22a in data repository 22 by keyword index creation module 21a. (step S103)

Next, document structure analysis module 21b analyses the structure of the document (step S104) by, for example, parsing the contents of a document, and generates document structure table 22b. The table will be used for showing a tree-like chart which indicates the structure of the document. If the logical structure of the document is hierarchical and all the contents of the document are marked up by using a markup language such as XML, the document structure analysis module can recognize the hierarchical structure of the document by parsing the contents and analyzing nesting relationship among markup tags. By repeating that operation, the document structure analysis module generates records for each structure unit such as topic or section or chapter, and stores the records into document structure table 22b. Each record includes node id for the structure unit, parent node id, title of the unit, and keyword indicator. The node id is used for identifying each structure unit such as topic or section or chapter, and assigned a sequential number such as a natural number starting from 1. The parent node id indicates node id for the upper unit such as section or chapter. For example, the parent node id in a record for a topic, and a section exists for the topic as an upper unit, then the parent node id is the node id for that section. The parent node id is used only when the upper unit exits. If no upper unit exits, a special node id (for example, 0) is set. The title field includes the title character string for the unit. No title might be assigned to a topic, and the value for the title field is set null in such a case. The keyword indicator is used as a filed to save all the keywords defined for the unit. The contents of the filed are index values for the keywords, not the keywords themselves. Because it is rather common to register multiple keywords for a single topic, multiple index values can be saved in the keyword indicator field. Document structure analysis module 21b finds index value for each keyword by referring to the keyword index table. The keyword indicator field for an upper unit such as section or chapter includes all the index values for the keywords registered to lower unit(s). If the total number of keywords is very large, a separate table can be defined to save the keyword index values. In this case, each record in the table consists of node id and a single index value for a keyword. If multiple keywords are registered to a single unit, multiple records with the same node id are saved in the table. That way, index values for the keywords registered to or related to each unit in a document can be managed with a single table.

As described above, document structure analysis module 21b generates document structure table 22b by tracing the structure of a document and creating records for each node in the document. If any keyword(s) are registered to topic Tc and/or section Tb and/or chapter Ta, document structure analysis module 21b records index values for that keywords in the records for topic, section, and chapter, respectively. After generating document structure table 22b, document structure analysis module 21b stores the table into data repository 22 (step S105). One of the possible formats of document contents data can be XML, but a specific mechanism, with which the contents data of a document are represented by document structure control data, keywords data, and topic contents data are kept separately, can also be adopted. For example, contents of topics and linkage among topics are expressed by HTML; Keywords are saved as a separate data; The relationship between keywords and topic contents are saved as document control data. In this case, document structure analysis module 21b can generate keyword index table 22a and document structure table 22b by using the same method as described above.

FIG. 5 shows internal processing flow when the user attempts to display the contents of topic Tc in a document. It is assumed that keyword index table 22a and document structure table 22b have been created. When the user attempts to open a document stored in document database 10, input processing module 24 generates open document event. The event is detected by event processing module 25 (step S201). Event processing module 25 notifies the event of document data processing module 23 (step S202).

Document data processing module 23 identifies which document should be processed from the event, and retrieves data for generating tree-like chart L showing the document structure by referring to document structure table 22b stored in data repository 22. It also retrieves contents data of topic Tc used for displaying initial screen image (step S203). Event processing unit 25 passes to view control module 26 all the data obtained from document data processing module 23.

Using the data, view control module 26 draws window W on the screen of display unit 30 as shown in FIG. 2. The internal area of window W is split into two frames F1 and F2. Tree-like chart L showing the logical structure of the document is shown in frame F1 and the contents of topic Tc are displayed in frame F2 as initial screen image (step S204). Nothing might be displayed as initial screen image.

In frame F1 of window W, the user clicks on the titles for chapter Ta or section Tb or topic Tc shown on tree-like document structure chart L in order to read the contents of the document. For example, if the user clicks on the title of topic Tc, the topic contents are displayed in frame F2. If the user encounters a word whose definition the user wants to know while reading the document, the user initiates keyword search in order to see if any description of the word can be found in the document.

FIG. 6 shows how keyword search operation is implemented by keyword search program 20 after the user initiates the search function. First, the user attempts to see what keywords are registered to topic Tc. As shown in FIG. 6, event processing module 25 receives the keyword check event generated by input processing module 24 after the user's attempt (step S301).

Event processing module 25 calls view control module 26 to detect topic Tc on which the mouse pointer is located or topic Tc whose contents are displayed in frame F2 (step S302). Next, event processing module 25 calls document data processing module 23 to get the keywords data registered to topic Tc. In order to respond the request form the event processing module 25, document processing module 23 refers to document structure table 22b stored in data repository 22 to get index values for the keywords. Then, using the obtained index values, document data processing module 23 gets all the keywords registered to topic Tc from keyword index table 22a stored in data repository 22 (step S303).

Document data processing module 23 returns all the keywords data to event processing module 25. The n event processing module 23 passes the keywords data to view control module 26. View control module 26 generates presentation data for showing popup menu Pm at the position of mouse pointer shown on window W displayed on display unit 30. The size of popup menu Pm is determined by the total number of the keywords to be shown on the menu. Thus, all the keywords registered to topic Tc (obtained in step S303) are listed on popup menu Pm as shown in FIG. 2 (step S304).

Keywords KW1 and KW2 that are registered to topic Tc and obtained in the process of S303 are displayed on pop-up menu Pm shown in FIG. 2. Keyword KW2 is a “linked keyword” related to keyword KW1. Keywords KW2 such as “Primary key”, “Outer join”, and “Normalization” have been registered as linked keywords to keyword KW1. FIG. 2 shows an example of those keywords displayed on the pop-up menu. The user lets the linked keywords be displayed by resting the mouse pointer around the “>” symbol next to keyword KW1 (in FIG. 2, the “>” symbol is displayed next to keyword “Table join”).

In addition to pre-registered keywords such as KW1 and KW2, pop-up menu Pm also includes menu item KWe which allows the user to open a dialog box to enter any desired keywords. The user enters character string to specify desired keyword on the dialog panel using input devices. Or it is possible to show a dialog panel on which the user selects any desired keyword from a keyword list or enters keyword directly into an input field.

The user can select keyword KW1 or one of keywords KW2 on pop-up menu Pm or input any desired keyword on the dialog box, thereby letting keyword search program 20 search the keyword. For example, when the user selects keyword KW2 “Outer join” on popup menu Pm shown in FIG. 2, keyword search program 20 searches both of keywords KW1 (Table join) and KW2 (Outer join).

FIG. 7 shows a flow chart that indicates how the search function is executed by keyword search program 20 when the user initiates keyword search by selecting keyword KW1 (or one of keywords KW2) or by entering keyword directly on the dialog box as described above (hereinafter, the selected or entered keyword will be referred to as “specified keyword”). As shown in FIG. 7, after event processing module 25 receives keyword search event, then it notifies document data processing module 23 of this event (step S401). Document data processing module 23 refers to keyword index table 22a stored in data repository 22 in order to search the specified keyword. If the specified keyword is found in keyword index table 22a, document data processing module 23 obtains the index value for the keyword (step S402).

Next, document data processing module 23 identifies topic Tc that includes index value for the specified keyword by referring to document structure table 22b stored in data repository 22. There might be multiple topics that include a single index value that corresponds to the specified keyword (step S403).

Document data processing module 23 obtains positional data of each of identified topics in the document structure (indicated by tree-chart L) by referring to document structure table 22b(step S404). In this case, positional data of each topic Tc includes information about both section Tb and chapter Ta that are upper layer of the topic, as well as the positional data of the topic itself.

Positional data obtained by the process as described above is returned to event processing module 25 and transferred to view control module 26. Then, based on the positional data, view control module 26 displays the search result, or the document structure chart in window W shown on display unit 30 as shown in FIG. 3 (step S405).

The search result is displayed as tree-like chart L in frame F1 with indicators M1 and M2 shown on titles for searched topics Tc. If the title for section Tb that includes topic Tc, or the title for chapter Ta that includes section Tb, is also displayed in the chart, then the indicators are also shown on the section or chapter title. Indicator M1 denotes the portion that includes specified keyword KW1. Indicator M2 denotes the portion that includes keyword KW2. If both indicators Ml and M2 are displayed at the same position, that means the portion pointed by both indicators include keywords KW1 and KW2.

The user can guess which topic appears to include description the user really wants by examining the positions of indicators M1 and M2 in the tree-like document structure chart, because the user can recognize what the topic with the indicator is all about from the topic's relative position in the document structure. That is, the user guesses topic contents by examining the title of the section that includes the topic or the title of the chapter that includes the section.

An example of an actual usage scenario will be described next using FIGS. 2, 3, and 8.

Suppose the user encounters phrase “by using outer join” while reading the contents of topic Tc displayed in frame F2. The topic is in a document about building a data processing system, and the topic title is “Query,” and the title of the section that includes the topic is “Designing tables.” The user is already familiar with the concept of joining tables, but not familiar with what word KWs (outer join) means, so the user might want to get information about the definition of “outer join” and how to use it.

The user positions mouse pointer on the title of topic Tc (Query), which is currently displayed on the tree chart (showing logical structure of the document) in frame F1. Then the user opens pop-up menu Pm on window W by, for example, clicking right button of the mouse, or selecting an item from menu bar, in order to initiate keyword search. Since keywords KW1 and KW2 have been registered to topic Tc (Query), they are displayed on pop-up menu Pm, thus enabling the user to recognize keyword KW1 (Table join) and keywords KW2 (Primary key, Outer join, and Normalization). Then the user decides to select “Outer join” for keyword search and initiates searching by using input devices. In this case, because keyword KW2 (Outer join) is linked to keyword KW1 (Table join), both keywords are automatically specified for the keyword search.

Initiated by the event generated by the user's operation using input devices, keyword search function is performed by keyword search program 20, and the search result is displayed on the screen of display unit 30 as shown in FIG. 3.

As shown in FIG. 3, the search result is displayed as tree-like chart L in frame F1 of window W with indicators M1 and M2 shown at the titles of topic Tc, section Tb that includes topic Tc, and chapter Ta that includes section Tb. The inside area of frame F1 is automatically scrolled so that the first unit in the document structure is shown on the tree-like chart in frame F1.

Indicator M1 is shown at the title of topic Tc since the topic includes keyword KW1 (table join), and the indicator is also shown at the titles of section Tb and chapter Ta since they are super group of the topic. Indicator M2 is shown in order to highlight a topic that includes keyword KW2 (outer join) and section and chapter that are super group of the topic.

If both indicators M1 and M2 are shown at the same position, that means a topic includes both keywords KW1 and KW2. In this case, a section and a chapter that are super group of the topic are also highlighted by indicators M1 and M2.

The user guesses which topic Tc includes description the user really wants by examining search result screen. In the example shown in FIG. 3, both indicators M1 and M2 are shown at section Tb (JOIN) in chapter Ta (SQL), as well as at topic Tc (General Rules). The user can recognize that keyword KWs (outer join) is included in the highlighted topics. In this example, it is assumed that the user wants to know the basic concept and definition of “outer join”. The user can recognize easily that topic Tc (General Rules) is about syntax description of the SQL language, if the user is a program developer. Thus, the user can guess that the desired description on “outer join” can be found in section Tb (JOIN).

If the user clicks on the title of topic Tb (JOIN), the contents of the topic is displayed in frame F2. Then the user reads the contents carefully to check if the description of “outer join” can be found in the contents. If the description is insufficient or is not the one the user needs, the user can scroll tree-like chart L in frame F1 as needed and tries to find appropriate topic(s) (or section(s) or chapter(s)) highlighted by indicators M1 and M2.

In the method described in the present invention, indicators M1 and M2 are displayed in tree-like chart L showing document structure and titles of topics, sections, and chapters in order to highlight topics that include the keywords the user specified. This enables the user to find topic Tc that appears to include description the user wants as if the user uses table of contents in a book in order to find desired information.

If the contents of topic Tc is displayed on the screen and the user clicks the right button of a mouse on the contents (or on the topic title), keywords KW1 and KW2 that are registered to topic Tc are displayed on pop-up menu Pm. Selecting keyword from this popup menu Pm is easy, so the user can specify search keyword correctly. In addition, a convenient way is provided for entering keyword directly; that is, the user can open a dialog box to enter keyword by selecting a special menu item on pop-up menu Pm. And linked keyword KW2 that relates to keyword KW1 provides an efficient way for keyword search.

The user does not need to perform prerequisite tasks such as generating document structure data and extracting keywords in a document because all these task are done by document analysis module 21. If a new document is saved in document database 10 and the contents of the document have been marked up with a markup language in order to indicate which words should be treated as keywords, all the necessary tasks described above is done by document analysis module 21. This automatic process makes the creation of base data for keyword search very efficient.

In the embodiment of the present invention, it is assumed that document database 10 is built on various kinds of locally-installed storage device such as HDD, etc. However, possible configuration of software and hardware for the present invention is not limited to the above example. For example, if document database 10 is configured as an external database, it is possible to connect to the external system from a PC or a terminal on which keyword search program 20 is run via network such as the Internet or LAN. Or it is also possible to distribute keyword search program 20 to an external server and to let the program perform keyword search from a remote client.

In the embodiment of the present invention, it is assumed that keyword index table 22a and document structure table 22b are referenced when performing keyword search. The contents of and format of the data stored in those tables are not limited to any specific or predetermined ones.

And presentation format of a document structure chart that is shown on the screen of display unit 30 is not limited to specific or predetermined one. Presentation format of indicators M1 and M2, which highlight topics that include specified keywords, is not limited, either. For example, title character strings for topics, sections, and chapters might be displayed in a different color to highlight keyword positions.

FIG. 9(a) shows an example of another style for displaying the logical structure of a document. The chart in FIG. 9(a) is a document structure chart (it can be referred to as sequence chart, or document system chart, or document structure chart) to show the relation among topics (unit documents) such as T1 and T2. The contents of the topics are marked up with HTML (Hypertext Markup Language) and are usually opened sequentially. The chart shows which linked topic should be opened when the user tries to open a hyper-linked word marked as “next” in the contents of, for example, topic T1.

When the user performs a predetermined operation with a specific topic (for example, T1) selected, pop-up menu Pm is displayed as shown in FIG. 9(b) just like in FIG. 2. On the pop-up menu, pre-registered keywords KW1 (and KW2; not shown) and a trigger item to open a dialog box to enter any character string are displayed.

If the user performs keyword search by selecting a keyword on pop-up menu Pm, indicator M3 is displayed at the topic that includes the specified keyword as shown FIG. 10(a) after the keyword search is completed. By evaluating the titles of topics T1, T3 and so on marked with indicators M3, the user can guess the portions that include the descriptions the user really needs. And, in the chart like the one shown in FIG. 10, the user can double-clicks on a specific topic (for example, T3) to open the topic and see the topic contents.

Furthermore, if multiple sequence sets exist in a document as shown in FIG. 10 (b), and a topic in other sequence than the one where the user initiated keyword search includes the specified keyword, the user can select which sequence set should be displayed by clicking tabs (S1, S2, etc.) in order to see the search result.

The actual modules of keyword search program 20 which realizes the keyword search function as proposed by the present invention can be recorded on any recording media such as CD-ROMs, DVD-ROMs, and hard disks, or can be loaded on physical memory so that the modules can be read by a computer.

The source device for sending those modules as described above can be composed of devices to read a CD-ROM or DVD-ROM, hard disk, and memory, and network devices to send the modules via the Internet, LAN, or the like. Such source device is suitable for installing the modules that is capable of performing keyword search described above on a PC or the like.

While the preferred form of the present invention has been described, it is to be understood that modifications will be apparent to those skilled in the field without departing from the concept of the invention.

### ADVANTAGES OF THE INVENTION

Using the search method described in the present invention, it is possible for the user to search keywords efficiently and find easily portions that include description that the user needs.

### BRIEF DESCRIPTION OF THE DRAWINGS

FIG. 1 is a module diagram of the keyword search system in an embodiment of the present invention;

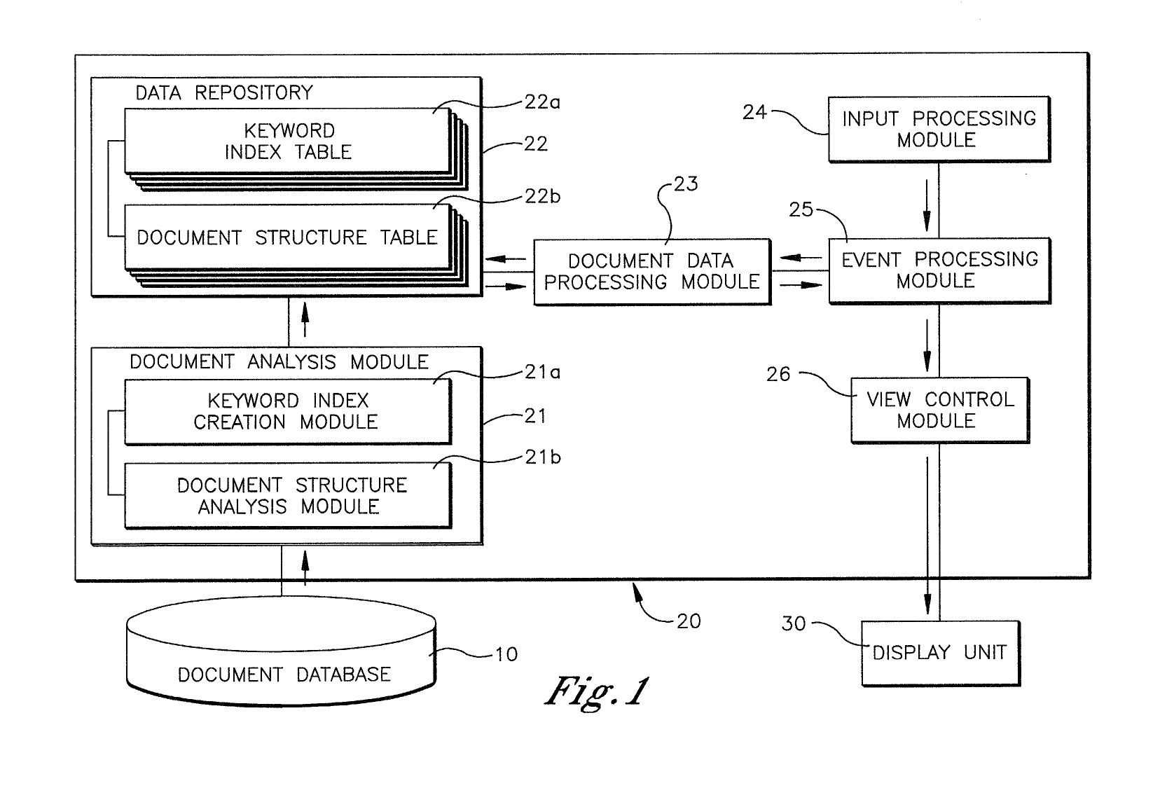

FIG. 2 is an example image of a pop-up menu that is displayed when the user initiates keyword search operation;

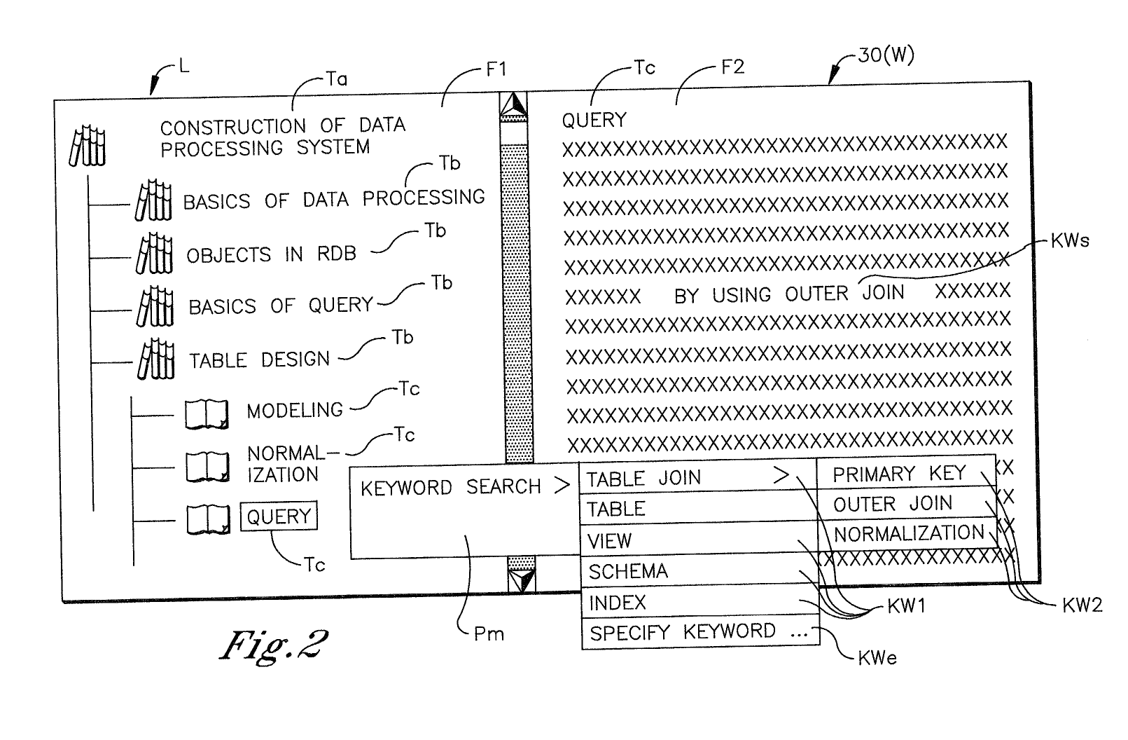

FIG. 3 is an example of search-result screen image that displays indicators showing the portions that include specified keyword(s);

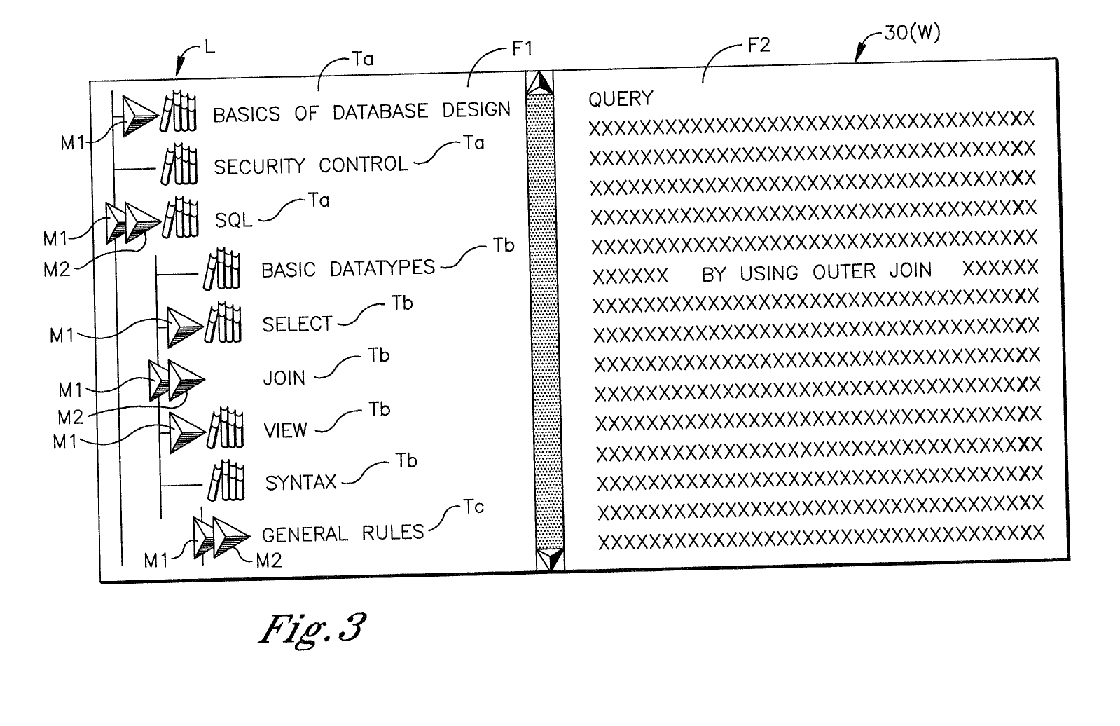

FIG. 4 is a flow c hart that shows the process of how keyword in dex table and document structure table are generated;

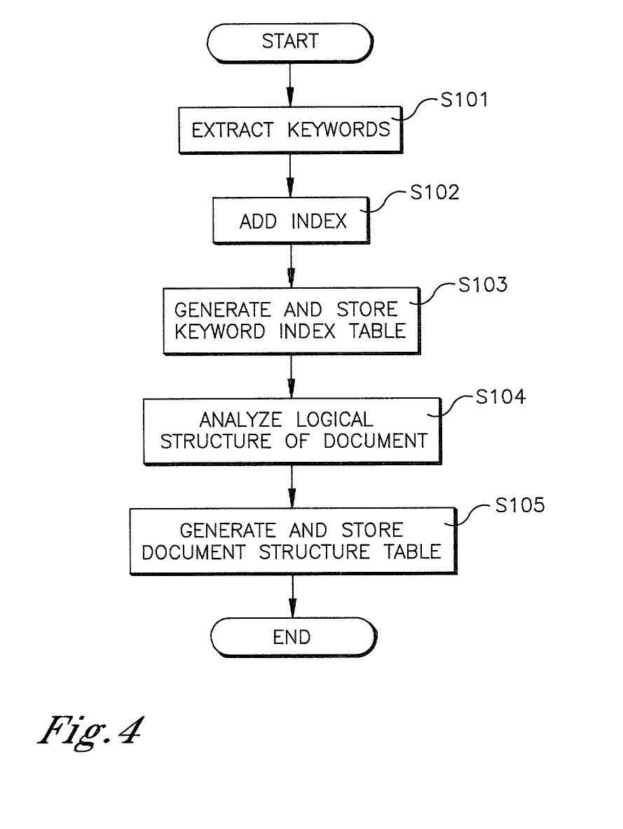

FIG. 5 is a flow chart that shows the process of how the contents of a specific topic in a document are displayed;

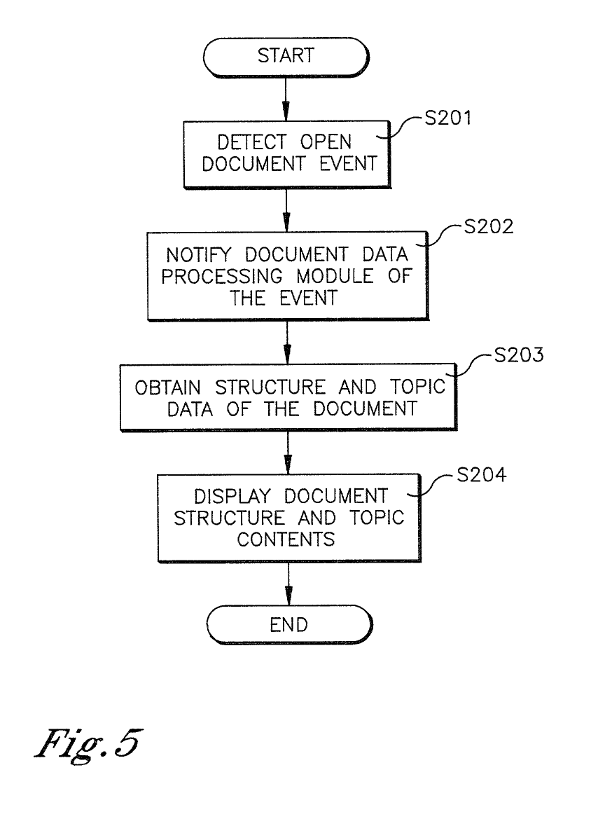

FIG. 6 is a flow chart that shows the process of how the keywords registered to a specific topic are listed;

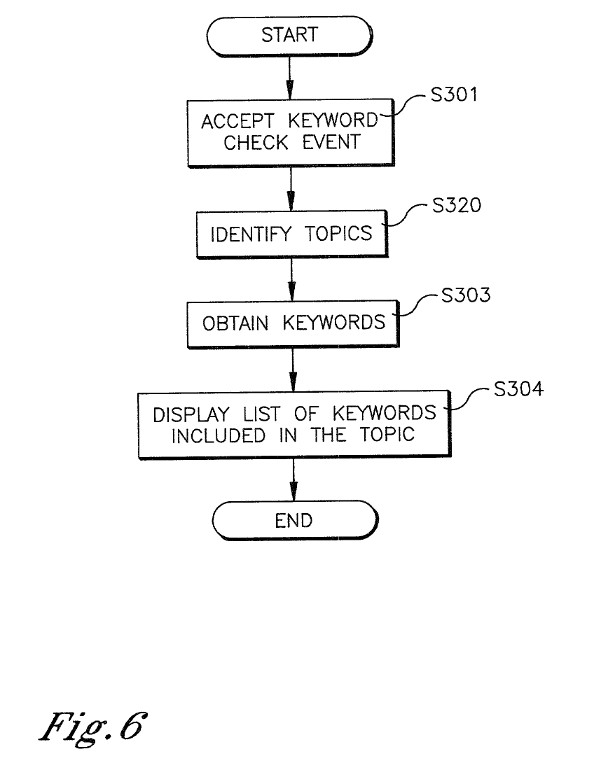

FIG. 7 is a flow chart that shows how keyword search function is processed;

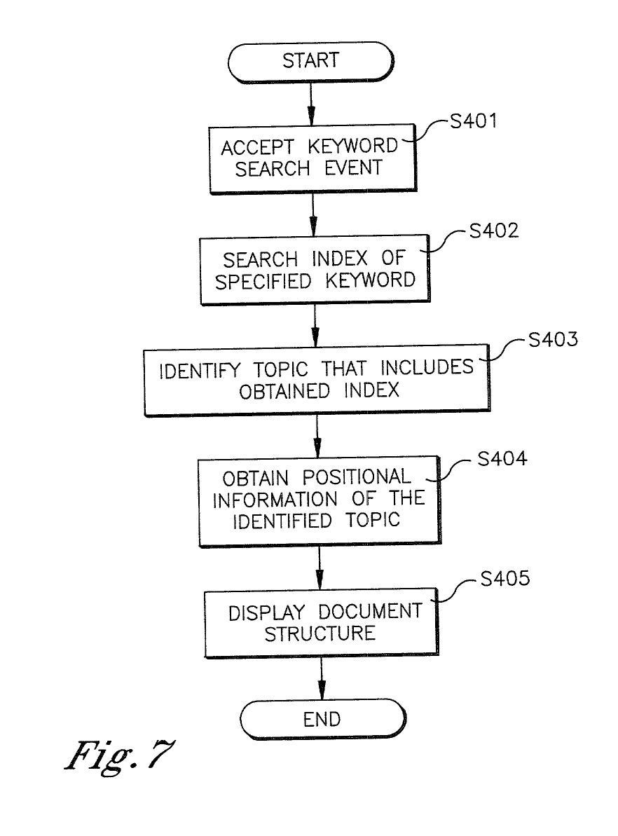

FIG. 8 is an example screen image that shows the keyword search result. In the left frame, indicators are displayed at the portions that include specified keywords, and the contents for a specific topic are displayed in another frame;

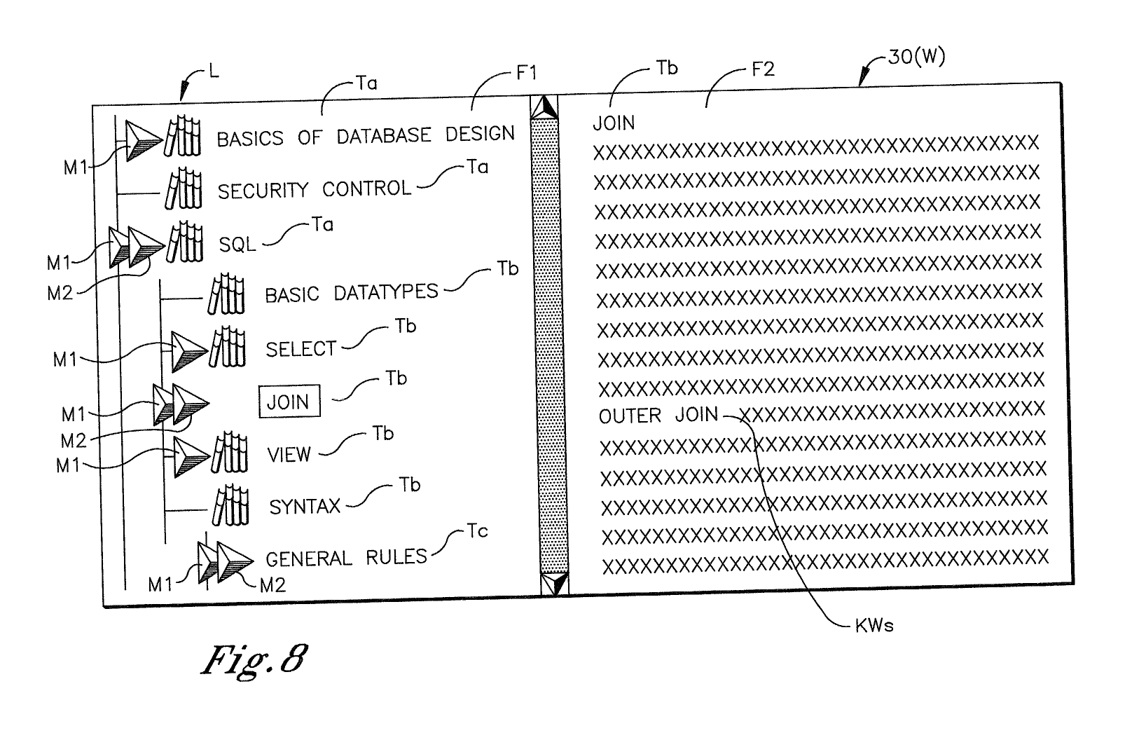

FIG. 9 is another example of a chart that shows logical structure of a document; and

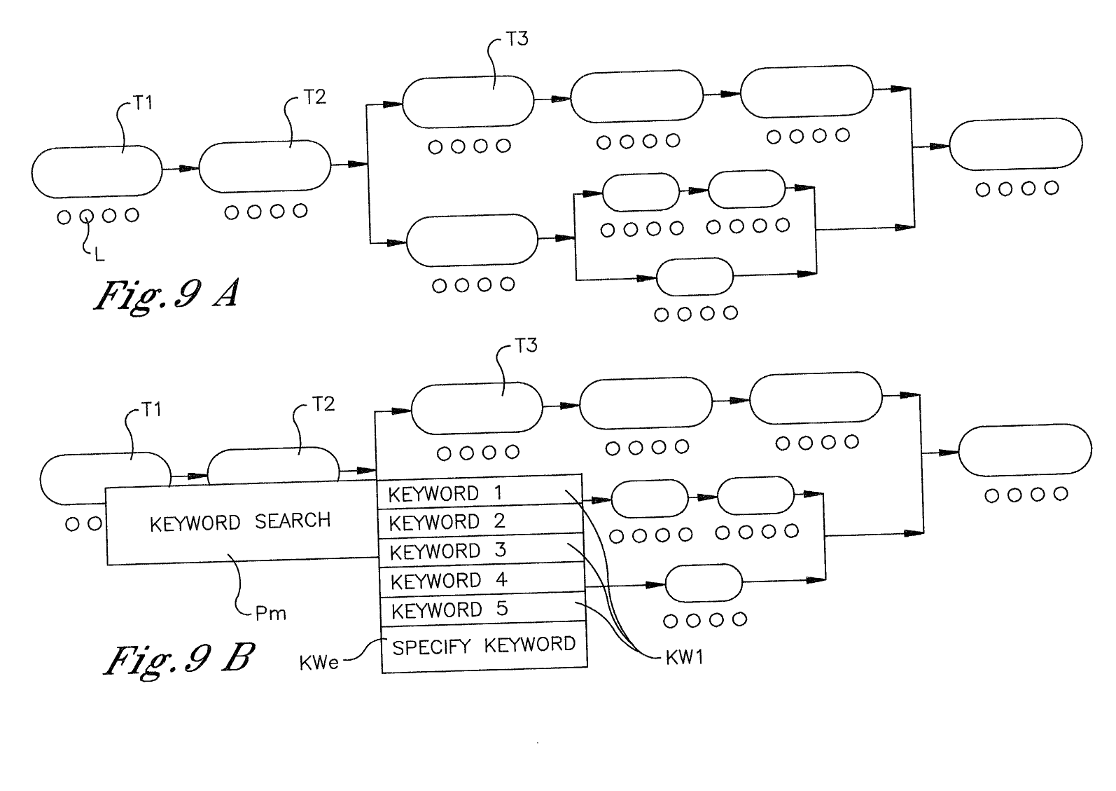

FIG. 10 is an example of search result screen image that shows how indicators are displayed at the portions that include specified keywords.

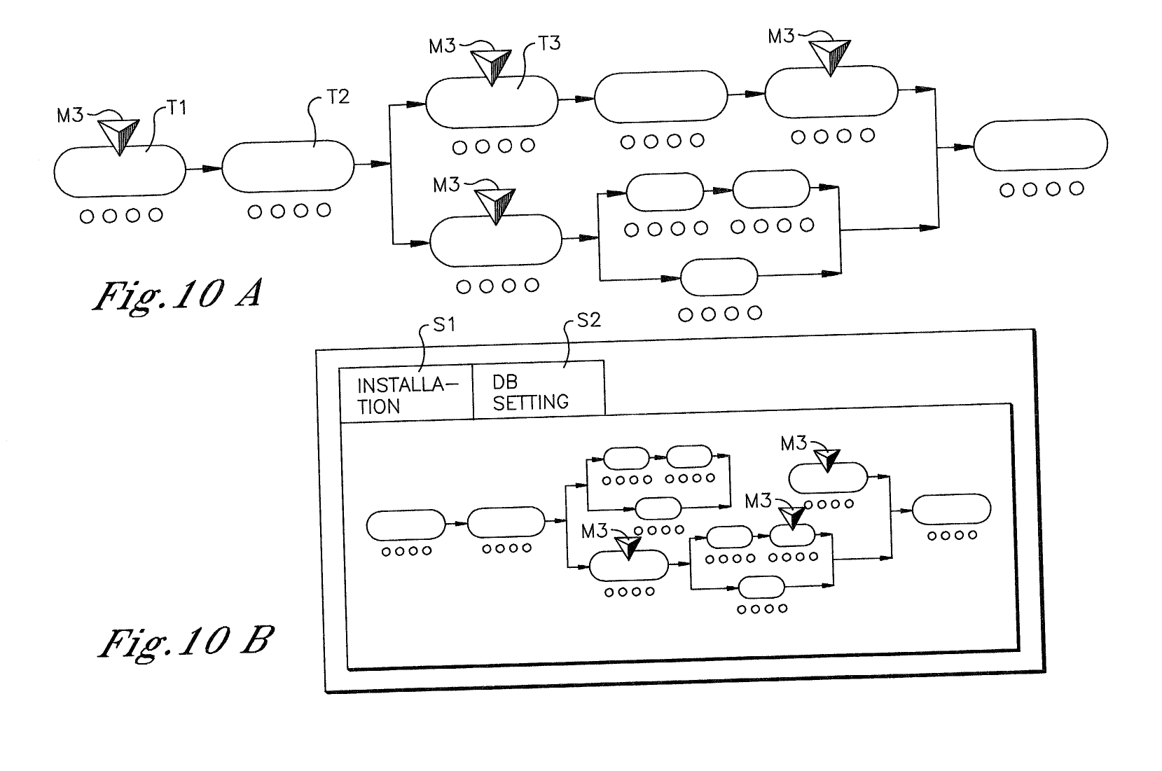

### DESCRIPTION OF SYMBOLS

10 . . . Document database (Database)

20 . . . Keyword search program

21 . . . Document analysis module

21a . . . Keyword index creation module (For generating index data for keyword search)

21b . . . Document structure analysis module (For generating a chart that shows the logical structure of a document)

22 . . . Data repository (For storing data for keyword search)

22a . . . Keyword index table (Data used for keyword search)

22b . . . Document structure table (Data used for keyword search)

23 . . . Document data processing module (For handling data for document structure and keyword index values in order to process keyword search request)

24 . . . Input processing module (For handling user's input to specify keywords)

30 . . . Display unit (For displaying search result) KW1, KW2 ... Keyword(s)

KWe . . . Menu item to open a dialog panel

L . . . Tree-like chart that shows document structure (Chart showing hierarchical structure in a document)

M1, M2, M3 . . . Indicators (Identification information)

Pm . . . Pop-up menu (List of keywords)

Ta Chapter (Group of sections)

Tb . . . Section (Group of topics)

Tc, T1, T2, T3 . . . Topic (Unit document)

We claim

1. A method for searching a document consisting of a plurality of unit documents by a keyword, data of said document being stored in a database, comprising:
accepting a specified keyword for search;
searching preregistered search data from said document to identify a unit document that contains said specified keyword; and
displaying a document structure chart that shows a relation among said plurality of unit documents of said document, as well as the indicator that specifies a unit document that contains said keyword in said chart.

2. The method according to claim 1, further comprising the steps of:
prior to said step of accepting a specified keyword, based on data of said document stored in said database extracting said keyword contained in said document and the positional information of said keyword in said document to generate said search data; and
extracting a relation among said plurality of unit documents of said document based on data of said document stored in said database to generate data of said document structure chart.

3. The method according to claim 1,
wherein said step of displaying said indicator comprises the steps of: displaying a
relation between a topic that is the minimum unit of said unit document and a group consisting of a plurality of topics as said document structure chart; and displaying said indicator for both a title of said topic that contains said keyword and a title of said group that contains said topic.

4. The method according to claim 1,
wherein said step of displaying said indicator comprises the steps of: displaying a sequence chart showing a relation among topics, each of said topics being the minimum unit of said unit document, as said document structure chart; and displaying said indicator for said topic that contains said keyword.

5. A method for searching a document consisting of a plurality of topics by a keyword, data of said document being stored in a database, comprising the steps of:
accepting a request for keyword search while said document is displayed;
identifying a topic of said document displayed when said request is accepted;
extracting a keyword registered in relation to said identified topic;
displaying a list of extracted keywords; accepting a keyword for search, specified in said list of keywords; and
searching said document for said specified keyword.

6. The method according to claim 5, wherein said list is displayed together with an input field for accepting input of a character string or a menu item for displaying said input field; and
wherein said step of searching, uses said character string inputted in said input field as a keyword for said searching.

7. The method according to claim 5, wherein said step of searching further includes: identifying a portion in said document, said portion containing said specified keyword; and displaying a structure chart of said document consisting of a plurality of topics together with the indicator that indicates a portion containing said keyword in said structure chart.

8. A terminal for searching a document consisting of a plurality of unit documents by a keyword, comprising:
a keyword accepting unit for accepting a search keyword; and
a search result displaying unit for displaying a document structure chart that shows a relation among said unit documents of said document together with the indicator that indicates a portion that contains said keyword in said document structure chart as a result of searching said document according to said specified keyword.

9. The terminal according to claim 8, further comprising:
a search data storing unit for storing search data in which a corresponding keyword is registered for each document; and
a searching unit for searching said search data and identifying a unit document that contains said specified keyword accepted by said keyword accepting unit.

10. The terminal according to claim 9, further comprising:
a search data generating unit for extracting a keyword contained in said document and a unit document related to said keyword based on data of said document to generate said search data stored in said database; and
a document structure chart generating unit for generating data of said document structure chart based on the data of said document, stored in said database.

11. A computer program product, in a computer-readable medium for performing a keyword search in a data processing system for a document of which data is stored in a database, comprising:
instructions for accepting a specified search keyword;
instructions for identifying a portion in said document, which contains said keyword; and
instructions for displaying a chart of the logical structure of said document together with the indicator that indicates a portion containing said keyword in said structure chart.

12. The computer program product according to claim 11, wherein said instructions for identifying the portion containing said keyword comprises instructions for searching preregistered search data from said document to identify the portion containing said keyword based on said search data.

13. The computer program product according to claim 11, further comprising:
prior to said instructions for accepting said specified keyword:
instructions for accepting a request for keyword search while said document is displayed;
instructions for identifying a topic of said document displayed when said request is accepted;
instructions for extracting a keyword registered in advance in relation to said identified topic; and
instructions for displaying a list of extracted keywords and prompting specification of a keyword for search in said list.

14. A computer program product, in a computer-readable medium, for searching a document, in a data processing system, by a keyword whose data is stored in a database, comprising:
instructions for generating search data by extracting a keyword contained in said document and information on a unit document related to said keyword based on data of said document stored in said database;
instructions for generating data of a document structure chart that shows a relation among unit documents of said document based on the data of said document stored in said database;
instructions for accepting a specified search keyword;
instructions for identifying a unit document that contains said keyword in said document; and
instructions for displaying the indicator that indicates said identified unit document in said document structure chart.

15. A computer program product, in a computer-readable medium, for performing a keyword search, in a data processing system for a document consisting of a plurality of topics, data of said document being stored in a database, comprising:
instructions for accepting a request for keyword search while said document is displayed;
instructions for identifying a topic of said document displayed when said request is accepted;
instructions for extracting a keyword registered in advance in relation to said identified topic;
instructions for displaying a list of extracted keywords to prompt specification of a keyword for search in said list; and
instructions for searching a keyword specified in response to said prompt in said document.
